(19) United States
(12) Patent Application Publication
(10) Pub. No.: US 2016/0118933 A1
(43) Pub. Date: Apr. 28, 2016

(54) ALTERNATING CURRENT PHOTOVOLTAIC MODULES

(71) Applicant: SUNEDISON, INC., Marylan Heights, MO (US)

(72) Inventors: Miles C. Russell, Lincoln, MA (US); Zachary A. King, Townsend, MA (US); Ruel D. Little, Concord, MA (US)

(21) Appl. No.: 14/892,816

(22) PCT Filed: May 20, 2014
(86) PCT No.: PCT/US2014/038789

§ 371 Date: Nov. 20, 2015

Related U.S. Application Data
(60) Provisional application No. 61/825,851, filed on May 21, 2013.

(51) Int. Cl. H02S 40/32; H02M 7/44; H02S 40/34

(52) U.S. Cl. CPC H02S 40/32; H02S 40/34; H02M 7/44

(57) ABSTRACT

Alternating current (AC) photovoltaic (PV) modules are described. In one example, an AC PV module includes a PV panel (100) having a top surface, a bottom surface, and a plurality of sides extending between the top surface and the bottom surface, a frame (104) adjacent the plurality of sides of the PV panel, a junction box (204) attached to the bottom surface of the PV panel, an inverter (214) adjacent the bottom surface of the PV panel, and at least one direct current (DC) conductor (206) extending from the junction box to the inverter. The DC conductor is prevented from contacting the frame and/or other grounded metal.

### CROSS REFERENCE TO RELATED APPLICATIONS

This application claims priority to U.S. provisional patent application Ser. No. 61/825,851, filed May 21, 2013, which is hereby incorporated by reference in its entirety.

### FIELD

This disclosure generally relates to photovoltaic (PV) modules, and more specifically, to alternating current (AC) PV modules.

### BACKGROUND

In some known solar power systems, a plurality of photovoltaic (PV) modules (also known as solar modules) are logically or physically grouped together to form an array of PV modules. Each PV module includes a PV laminate (also known as a solar laminate) that converts solar energy into electrical energy. The electrical energy may be used directly, converted for local use, and/or converted and transmitted to an electrical grid or another destination.

PV modules generally output direct current (DC) electrical power. To properly couple such PV modules to an electrical grid, or otherwise provide alternating current (AC) power, the electrical power received from the solar modules is converted from DC to AC power using a DC/AC inverter. Some known systems couple the DC output of more than one PV module to a single inverter. In some systems, an array of PV modules includes a plurality of PV modules arranged in strings of PV modules. Each string of modules is connected to a single inverter to convert the DC output of the string of PV modules to an AC output. In at least some other known systems, each PV module is coupled to its own inverter. Each inverter may be positioned near or on the PV module to which it is electrically coupled. A PV module including an inverter electrically and mechanically coupled to the PV module is sometimes generally known as an AC PV module.

FIG. 1 is a bottom plan view of a known AC PV module 10 including a PV module 12 and an inverter 14. The PV module 12 includes a solar laminate 16 and a frame 18. The inverter 14 is adhesively bonded to the bottom surface of the solar laminate 16. The inverter 14 includes a housing 20 enclosing the components (not shown) of the inverter 14. The DC power output of the solar laminate 16 enters directly from the bottom surface of the laminate 16 into the housing 20 of the inverter 14 (e.g., by ribbon conductors extending from the laminate 16 through an opening in the housing 20 adjacent the bottom surface of the laminate 16). Two AC cables 22 extend out from the inverter 14 to carry the AC output of the inverter 14. The AC PV module 10 has no exposed DC wiring. The DC connection from the laminate 16 to the inverter 14 is covered by the housing 20. The power output from the inverter 14 through the cables 22 is AC power. The absence of exposed and/or field accessible DC conductors permitting the AC PV module 10 to be certifiable as an AC PV module under various electric codes and electric safety standards.

FIG. 2 is a bottom plan view of known AC microsystem 30. Microsystem 30 includes PV module 12 and inverter 14, and outputs AC power. However, microsystem 30 generally is not certifiable as an AC PV module under electrical codes and electrical safety standards because microsystem 30 includes exposed and field accessible DC wiring. The DC power output of the solar laminate 16 enters a junction box 32 adhered to the bottom surface of the solar laminate 16. Two DC cables 34 extend out from the junction box 32. The DC cables 34 carry the DC output of the solar laminate 16 to the inverter 14. The DC cables 34 are connected to the inverter 14 by DC connectors 36. DC connectors 36 allow the junction box 32 (and accordingly the DC output of the solar laminate 16) to be disconnected from the inverter 14. Microsystem 30 includes a ground fault detection and interruption (GFDI) circuit (not shown). Microsystem 30 includes exposed and field accessible DC wiring (e.g., DC cables 34) which may prevent microsystem 30 from being certified as an AC module under various electrical codes and electrical safety standards due to the potential for live DC conductors contacting the frame 18 and/or other grounded metal such as a mounting structure for the microsystem 30.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF SUMMARY

According to one aspect of this disclosure, an alternating current (AC) photovoltaic (PV) module includes a PV panel having a top surface, a bottom surface, and a plurality of sides extending between the top surface and the bottom surface, a frame adjacent the plurality of sides of the PV panel, a junction box attached to the bottom surface of the PV panel, an inverter adjacent the bottom surface of the PV panel, and at least one direct current (DC) conductor extending from the junction box to the inverter. The DC conductor is prevented from contacting the module frame.

Another aspect of this disclosure is a method of assembling an alternating current (AC) photovoltaic (PV) module including a PV panel, a frame, a junction box, an inverter, and at least one direct current (DC) conductor extending from the junction box to the inverter. The method includes attaching the junction box to a bottom surface of the PV panel, attaching the inverter to the PV module adjacent the bottom surface of the PV panel, and preventing the at least one DC conductor from contacting the frame.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a bottom plan view of a known alternating current (AC) photovoltaic (PV) module;

FIG. 2 is a bottom plan view of a known AC microsystem;

FIG. 3 is a top perspective view of an example photovoltaic (PV) module;

FIG. 4 is a cross-sectional view of the PV module shown in FIG. 3 taken along the line A--A;

FIG. 5 is a block diagram of an AC PV module including the PV module shown in FIG. 3;

FIG. 6 is a bottom view of an example embodiment of the AC PV module shown in FIG. 5.

FIG. 7 is a bottom view of another example embodiment of the AC PV module shown in FIG. 5.

FIG. 8 is a bottom view of another example embodiment of the AC PV module shown in FIG. 5.

FIG. 9 is a view of a portion of an AC PV module array attached to a mounting structure; and

FIG. 10 is a simplified view of the bottom of an AC PV module.

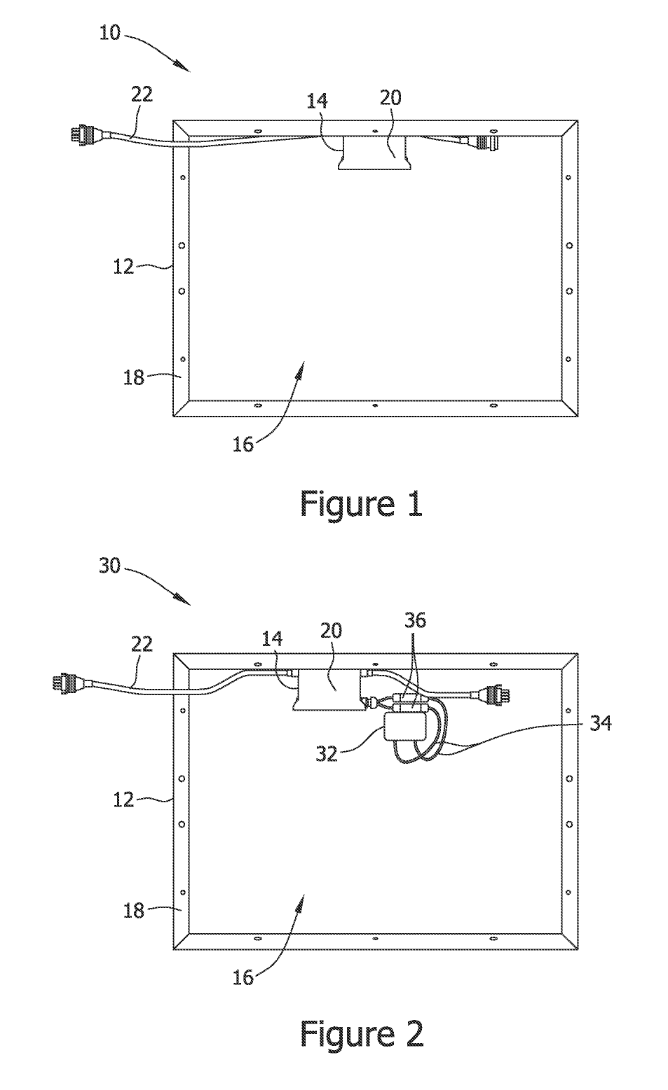

Like reference symbols in the various drawings indicate like elements.

### DETAILED DESCRIPTION

The embodiments described herein generally relate to photovoltaic (PV) modules. More specifically, the embodiments described herein relate to alternating current (AC) PV modules.

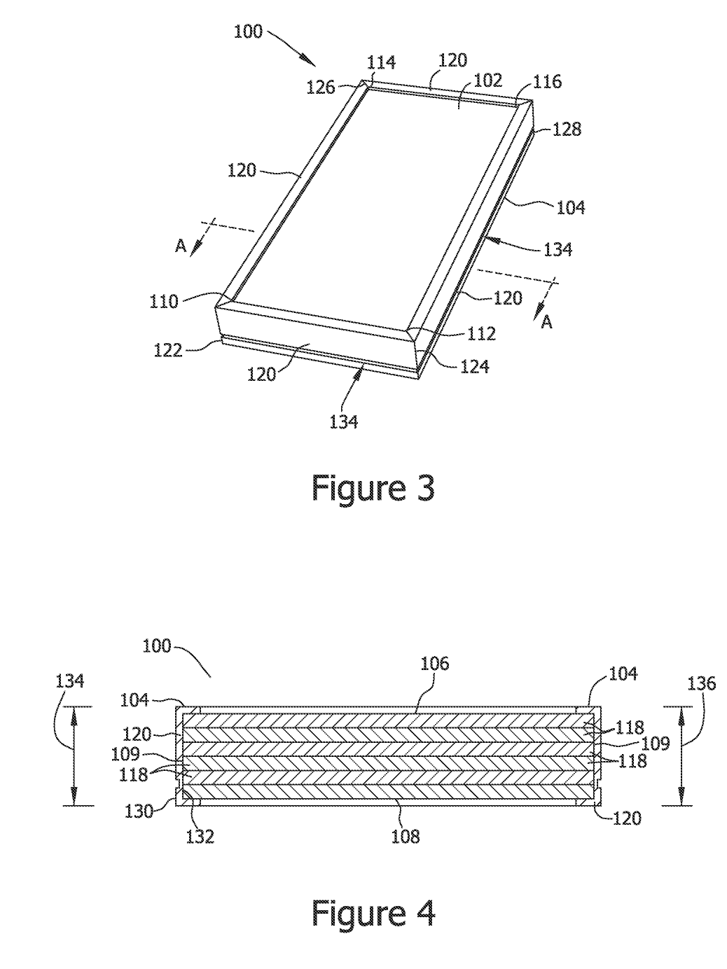

Referring initially to FIGS. 3 and 4, a PV module is indicated generally at 100. A perspective view of PV module 100 is shown in FIG. 3. FIG. 4 is a cross sectional view of PV module 100 taken at line A-A shown in FIG. 3. PV module 100 includes a solar laminate 102 (also sometimes referred to as a PV laminate) and a frame 104 circumscribing solar laminate 102.

Solar laminate 102 includes a top surface 106 and a bottom surface 108 (shown in FIG. 4). Edges 109 extend between top surface 106 and bottom surface 108. In this embodiment, solar laminate 102 is rectangular shaped. In other embodiments, solar laminate 102 may have any suitable shape. In the exemplary embodiment, solar laminate 102 defines four corners 110, 112, 114, and 116.

As shown in FIG. 4, this solar laminate 102 has a laminate structure that includes several layers 118. Layers 118 may include for example glass layers, non-reflective layers, electrical connection layers, n-type silicon layers, p-type silicon layers, and/or backing layers. In other embodiments, solar laminate 102 may have more or fewer, including one, layers 118, may have different layers 118, and/or may have different types of layers 118.

As shown in FIG. 3, frame 104 circumscribes solar laminate 102. Frame 104 is coupled to solar laminate 102, as best seen in FIG. 4. Frame 104 assists in protecting edges 109 of solar laminate 102. In this embodiment, frame 104 is constructed of four frame members 120. In other embodiments frame 104 may include more or fewer frame members 120. In the exemplary embodiment, frame 104 defines four corners 122, 124, 126, and 128, which may also be referred to as the corners of PV module 100. Frame 104 includes a channel 134 extending from outer surface 130 of frame 104 toward inner surface 132. Other embodiments do not include a channel 134, include a different channel, and/or include a different number of channels 134. In the illustrated embodiment, the frame 104 is substantially the same height 134 as a thickness 136 of the solar laminate 102. In other embodiments, the frame 104 has a height 134 greater than the thickness 136 of the solar laminate 102.

Exemplary frame 104 includes an outer surface 130 spaced apart from solar laminate 102 and an inner surface 132 adjacent solar laminate 102. Outer surface 130 is spaced apart from and substantially parallel to inner surface 132. In this embodiment, frame 104 is made of aluminum. More particularly, in some embodiments frame 104 is made of 6000 series anodized aluminum. In other embodiments, frame 104 may be made of any other suitable material providing sufficient rigidity including, for example, rolled or stamped stainless steel, plastic, or carbon fiber. Moreover, frame 104 may have any other suitable shape and/or profile.

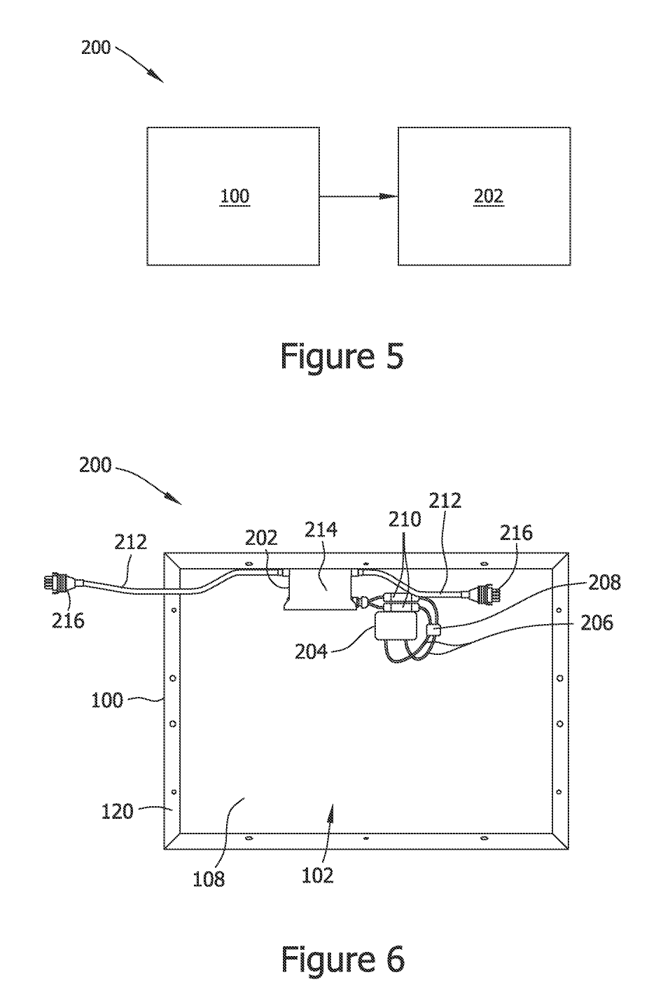

FIG. 5 is a block diagram of an example alternating current (AC) PV module 200. The AC PV module 200 includes the PV module 100 and an inverter 202. In some embodiments, the inverter 202 is attached to the bottom surface 108 of the solar laminate 102. In other embodiments, the inverter 202 is attached to the frame 104 of the PV module 100 adjacent the bottom surface 108 of the solar laminate 102, whether in contact with the bottom surface 108 or spaced apart from the bottom surface 108.

The PV module 100 provides its DC power output to the inverter 202. The inverter 202 converts the DC power to an AC power output. The exemplary inverter 202 is a two stage power converter including a first stage and a second stage (not shown). The first stage is a DC/DC power converter that receives a DC power input from the PV module 100 and outputs DC power to the second stage. The DC/DC converter may be any suitable DC/DC converter including, for example, a buck converter, a boost converter, a buck-boost converter, an LLC DC/DC converter, etc. The second stage is a DC/AC power converter that converts DC power received from the first stage to an AC power output. The second stage may be any suitable DC/AC power converter including, for example, an H-bridge. In other embodiments, inverter 202 may include more or fewer stages. More particularly, in some embodiments inverter 202 includes only a single stage. The AC PV module 200 includes at least one exposed and/or field accessible DC conductor (not shown in FIG. 5). The DC conductor is configured to prevent contact with the frame and/or a mounting structure coupled to the AC PV module 200.

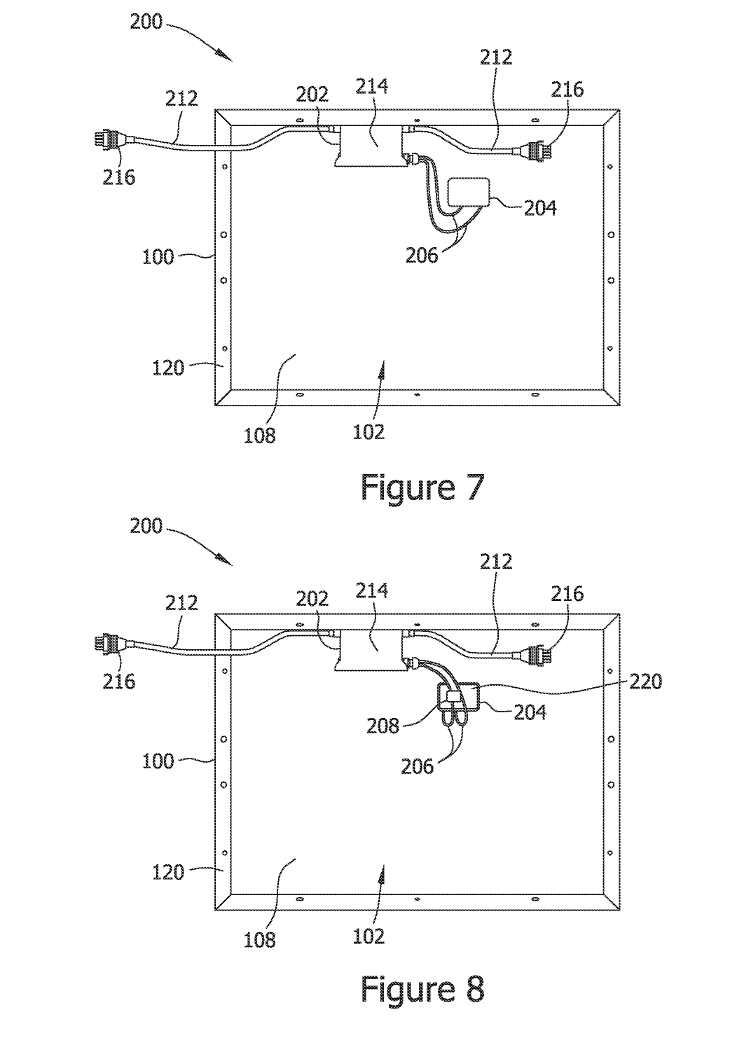

FIG. 6 is a bottom plan view of an embodiment of the AC PV module 200. The inverter 202 is attached to the PV module 100 adjacent the bottom surface 108 of the solar laminate 102. The DC power output of the solar laminate 102 enters a junction box 204 adhered to the bottom surface 108 and two DC cables 206 carry the DC power from the junction box 204 to the inverter 202. The DC cables 206 are configured to prevent contact with the frame 104 and/or a mounting structure (not show in FIG. 6). More specifically, the DC cables 206 are attached to the bottom surface 108 of the laminate 102 to retain the cables 206 in place and prevent the cables 206 from contacting the frame 104 and/or the mounting structure, even if the insulation of the DC cables 206 is broken, breached, or otherwise compromised. In the illustrated embodiment, the cables 206 are attached to the bottom surface of the laminate 102 by a mounting block 208 adhered (e.g., adhesively attached) to the bottom surface 108. The DC cables 206 pass through at least a portion of the mounting block 208. In some embodiment, the DC cables 206 do not pass through the mounting block and are attached to the mounting block instead by a cable tie (not shown) that passes through at least a portion of the mounting block 208. In still other embodiments, any suitable method for attaching the DC cables 206 to the bottom surface 108 of the laminate 102 may be used. In some embodiments, the module 200 is configured so that the DC cables 206 do not cross over each other between the junction box 204 and the inverter 202. For example, each DC cable 206 may be retained by a separate mounting block 208, by separate guide channels, or by any other suitable feature for preventing the DC cables 206 from crossing over each other. Thus, the likelihood of an electrical short between the DC cables 206, such as in the event of a breach of the insulation of one DC cable, is reduced or eliminated. The embodiments shown in FIGS. 7 and 8 include DC cables that are prevented from crossing over each other. The same or similar features may be incorporated in the AC PV module 206 shown in FIG. 6.

The DC cables 206 are connected to the inverter by DC connectors 210. The DC connectors 210 allow the junction box 204 (and accordingly the DC output of the solar laminate 102) to be disconnected from the inverter 202. Other embodiments do not include the DC connectors 210. The AC PV module 200 does not include a ground fault detection and interruption (GFDI) circuit. Two AC cables 212 extend out from the inverter 202 (and more particularly from a housing 214 of the inverter 202). The AC cables 212 are coupled to the output of the inverter 202 to carry the AC output of the inverter 202. The AC cables 212 include connectors 216 that are configured for connection to similar connectors to permit connection of multiple like AC PV modules 200 and/or for connection to a junction box or service panel (neither shown).

Although the AC PV module 200 shown in FIG. 6 has exposed and field accessible DC wiring, the DC wiring (e.g. cables 206) are prevented from contacting the frame 104 or a mounting structure for the module 200 (not shown in FIG. 6). Thus, the illustrated AC PV module 200 should be certifiable as an AC module under various electrical codes and electrical safety standards. Because the AC PV module 200 may be certified as an AC PV module, DC connectors 210 and a GFDI circuit may be omitted from the AC PV module.

FIG. 7 is a bottom plan view of another embodiment of the AC PV module 200. The inverter 202 is attached to the PV module 100 adjacent the bottom surface 108 of the solar laminate 102. The DC power output of the solar laminate 102 enters the junction box 204 and two DC cables 206 carry the DC power from the junction box 204 to the inverter 202. In this embodiment, the DC cables 206 are prevented from contacting the frame 104 or a mounting structure (not shown in FIG. 7) by their short length. In this embodiment, a short length means, in the plane of the PV module 200, the DC cable 206 that extends from the junction box 204 to the microinverter 202 has a sufficiently short length that it does not extend to the module frame; and in the orthogonal direction, the cable 206 has a sufficiently short length such that it does not extend to any metal (for example to the mounting rails or racks). The DC cables 206 each have a length that prevents the cables 206 from drooping to contact the frame 104 or the mounting structure regardless of whether or not the insulation of the DC cables 206 is broken, breached, or otherwise compromised.

In the illustrated embodiment, the DC cables 206 are connected directly to the inverter 202 without any DC connectors. Other embodiments include DC connectors (such as DC connectors 210 shown in FIG. 6). The AC PV module 200 does not include a ground fault detection and interruption (GFDI) circuit. Alternatively, the AC PV module 200 may include a GFDI circuit. Two AC cables 212 extend out from the inverter 202 (and more particularly from a housing 214 of the inverter 202). The AC cables 212 are coupled to the output of the inverter 202 to carry the AC output of the inverter 202. The AC cables 212 include connectors 216 that are configured for connection to similar connectors to permit connection of multiple like AC PV modules 200 and/or for connection to a junction box or service panel (neither shown).

Although the AC PV module 200 shown in FIG. 7 has exposed and field accessible DC wiring, the DC wiring (e.g. cables 206) are prevented from contacting the frame 104 and/or a mounting structure for the module 200 (not shown in FIG. 7). Thus, the illustrated AC PV module 200 should be certifiable as an AC module under various electrical codes and electrical safety standards. Because the AC PV module 200 may be certified as an AC module, DC connectors 210 and a GFDI circuit may be omitted from the AC PV module.

FIG. 8 is a bottom plan view of another embodiment of the AC PV module 200. The inverter 202 is attached to the PV module 100 adjacent the bottom surface 108 of the solar laminate 102. The DC power output of the solar laminate 102 enters the junction box 204 adhered to the bottom surface 108 and two DC cables 206 carry the DC power from the junction box 204 to the inverter 202. The AC PV module 200 prevents the DC cables 206 from contacting the frame 104 and/or a mounting structure (not shown in FIG. 8). The DC cables 206 are attached to the housing 220 of the junction box 204 to retain the cables 206 in place and prevent the cables 206 from contacting the frame 104 and/or the mounting structure, even if the insulation of the DC cables 206 is broken, breached, or otherwise compromised.

In the illustrated embodiment, the cables 206 are attached to the junction box 204 by mounting block 208 adhered (e.g., adhesively attached) to the housing 220 of the junction box 204. The DC cables 206 pass through at least a portion of the mounting block 208. In some embodiments, the DC cables 206 do not pass through the mounting block and are attached to the mounting block instead by a cable tie (not shown) that passes through at least a portion of the mounting block 208. In still other embodiments, any suitable method for attaching the DC cables 206 to the junction box 204 may be used. For example, the junction box 204 may include a suitable cable retaining feature (whether separately attached or integrally formed therewith), such as integral hook(s), cable guides, cable troughs, holes, etc. for retaining the DC cables 206. Moreover, in some embodiments, the cables 206 are attached to the bottom surface 108 of the laminate 102 (as shown in FIG. 6) and the housing 220 of the junction box 204 (as shown in FIG. 8).

In the illustrated embodiment, the DC cables 206 are connected directly to the inverter 202 without any DC connectors. Other embodiments include DC connectors (such as DC connectors 206 shown in FIG. 6). The AC PV module 200 does not include a ground fault detection and interruption (GFDI) circuit. Two AC cables 212 extend out from the inverter 202 (and more particularly from a housing 214 of the inverter 202). The AC cables 212 are coupled to the output of the inverter 202 to carry the AC output of the inverter 202. The AC cables 212 include connectors 216 that are configured for connection to similar connectors to permit connection of multiple like AC PV modules 200 and/or for connection to a junction box or service panel (neither shown).

Although the AC PV module 200 shown in FIG. 8 has exposed and field accessible DC wiring, the DC wiring (e.g. cables 206) are prevented from contacting the frame 104 and/or a mounting structure for the module 200 (not shown in FIG. 8). Thus, the illustrated AC PV module 200 may be certifiable as an AC module under various electrical codes and electrical safety standards. Because the AC PV module 200 may be certified as an AC module, DC connectors 210 and a GFDI circuit may be omitted from the AC PV module.

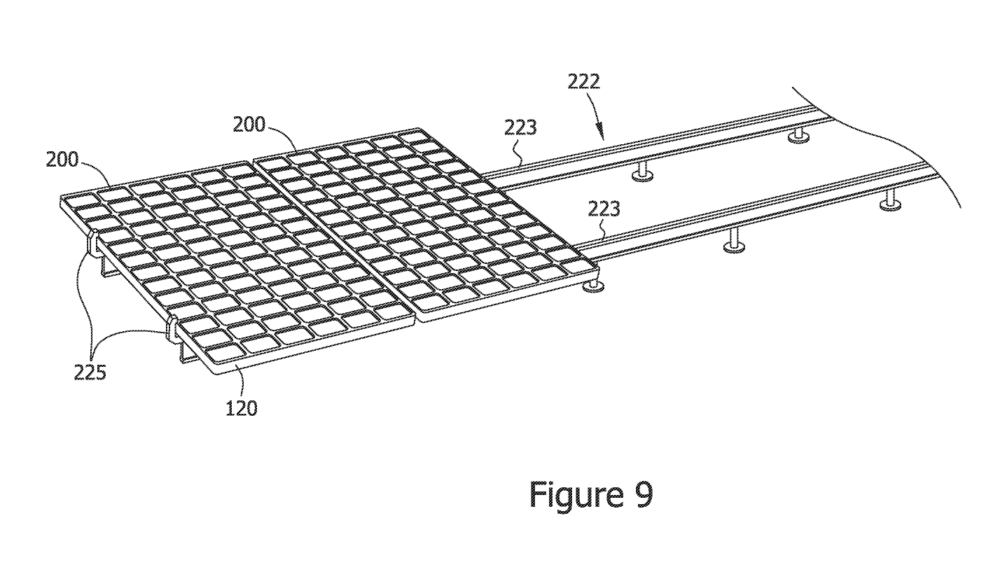

FIG. 9 is a view of AC PV modules 200 with an example mounting structure 222. AC PV modules 200 may be mounted with any other suitable mounting structure. In this embodiment, the AC PV modules 200 are supported by beams 223 of the mounting structure 222 and held in place by clamps 225 coupled between the beams 223 and the frame 104 of the AC PV module 200. Additionally or alternatively, the AC PV modules 200 may be attached to the mounting structure 222 by bolts or any other suitable fastening system. Although only two beams 223 are shown in FIG. 9, more than two beams 223 may be used to support PV module 200. The mounting structure 222 is configured for mounting the AC PV modules 200 on any suitable support structure.

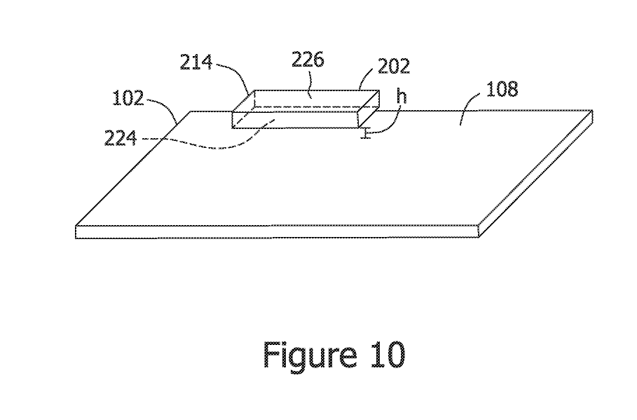

FIG. 10 is a simplified view of the inverter 202 and the solar laminate 102 of the AC PV module 200. The housing 214 of the inverter has a first surface 224 positioned adjacent the bottom surface 108 of the solar laminate 102. The first surface 224 is spaced apart from the bottom surface 108 (e.g. positioned above the bottom surface 108 of the laminate 102 by a distance h), such as by attachment to the frame (not shown in FIG. 10) of the AC PV module 200. The inverter housing 214 also has a second surface 226 opposite the first surface 224. The second surface 226 faces away from the bottom surface 108. To aid removal of heat from the inverter 202, the second surface of the inverter housing 214 may be provided with a highly emissive coating or treatment to increase radiative heat transfer from the inverter 202. The highly emissive coating or treatment may include, for example, black paint, black anodizing, or any other suitable emissive finishing. Further, the first surface of the inverter may be provided with a low-absorptivity coating to reduce the radiated heat transfer from the solar laminate 102 to the inverter 202. The low-absorptivity coating may be any suitable coating for reducing the transfer of heat from the solar panel surface 108 to the inverter surface 224, including for example white paint, silver paint, etc.

The AC PV modules described herein provide an efficient combination of PV module with field repairable/replaceable inverter. The exemplary AC PV modules include exposed and accessible DC wiring, yet prevent the DC wiring from contacting frames and/or support structures of the module. Thus the exemplary AC PV modules are certifiable as AC modules under various electrical codes and/or electrical safety standards, thereby permitting omission of DC connectors and GFDI circuits.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

1. An alternating current (AC) photovoltaic (PV) module comprising:
a PV panel comprising a top surface, a bottom surface, and a plurality of sides extending between the top surface and the bottom surface;
a frame adjacent the plurality of sides of the PV panel;
a junction box attached to the bottom surface of the PV panel;
an inverter adjacent the bottom surface of the PV panel; and
at least one direct current (DC) conductor extending from the junction box to the inverter, wherein the at least one DC conductor is configured to prevent contact with the frame.

2. The AC PV module of claim 1, wherein the at least one DC conductor has a length between the junction box and the inverter such that the at least one DC conductor cannot contact the frame.

3. The AC PV module of claim 1, wherein the at least one DC conductor is attached to the bottom surface of the PV panel at a position along the at least one DC conductor extending from the junction box to the inverter.

4. The AC PV module of claim 3 further comprising a mounting base attached to the bottom surface of the PV panel, and wherein the at least one DC conductor is attached to the bottom surface of the PV panel by attachment to the mounting base.

5. The AC PV module of claim 4, wherein the at least one DC conductor is attached to the mounting base by a cable tie.

6. The AC PV module of claim 1, wherein the at least one DC conductor exits the junction box at an exit location, and wherein the DC conductor is attached to the junction box at a location on the junction box other than the exit location.

7. The AC PV module of claim 1, wherein the at least one DC conductor is connectorless between the junction box and the inverter.

8. The AC PV module of claim 1, wherein the at least one DC conductor comprises at least two DC conductors, and wherein the at least two DC conductors do not cross each other between the junction box and the inverter.

9. The AC PV module of claim 1, wherein the inverter is mechanically attached to the frame.

10. The AC PV module of claim 8 further comprising an AC output cable extending from the inverter and configured to carry AC power output by the inverter.

11. The AC PV module of claim 10, wherein the AC output cable extends from the inverter at a location proximate the frame.

12. The AC PV module of claim 1, wherein the inverter comprises a housing having a first surface and a second surface opposite the first surface, the first surface including a low absorptivity coating and being positioned adjacent the bottom surface of the PV panel.

13. The AC PV module of claim 12, wherein the second surface includes at least one of a highly emissive coating and a treatment to provide for improved heat transfer from the inverter.

14. The AC PV module of claim 1, wherein the at least one DC conductor is further configured to prevent contact with a mounting structure when the AC PV module is mounted to the mounting structure.

15. A method of assembling an alternating current (AC) photovoltaic (PV) module including a PV panel, a frame, a junction box, an inverter, and at least one direct current (DC) conductor extending from the junction box to the inverter, the method comprising:
attaching the junction box to a bottom surface of the PV panel;
attaching the inverter to the PV module adjacent the bottom surface of the PV panel; and
preventing the at least one DC conductor from contacting the frame.

16. The method of claim 15, wherein the at least one DC conductor exits the junction box at an exit location, and preventing the DC conductor from contacting the frame comprises connecting the inverter to the junction box using a DC conductor having a stretched length less than a distance between the exit location and the frame.

17. The method of claim 15, wherein the at least one DC conductor exits the junction box at an exit location and enters the inverter at an inverter location, and preventing the DC conductor from contacting the frame comprises connecting the inverter to the junction box using a DC conductor having a length such that no portion of the at least one DC conductor between the exit location and the inverter location is capable of touching the frame when the at least one DC conductor is substantially fixed in position at the exit location and the inverter location.

18. The method of claim 15, wherein preventing the DC conductor from contacting the frame comprises attaching the DC conductor to the bottom surface of the PV panel.

19. The method of claim 15 further comprising preventing the DC conductor from contacting a mounting structure when the AC PV module is mounted to the mounting structure.

20. The method of claim 15, wherein the at least one DC conductor comprises at least two DC conductors, and further comprising preventing the at least two DC conductors from crossing each other between the junction box and the inverter.
